(19) United States
(12) Patent Application Publication
(10) Pub. No.: US 2018/0196623 A1
(43) Pub. Date: Jul. 12, 2018

(54) PRINT OUTPUT MANAGEMENT SYSTEM AND THE METHOD OF OPERATION THEREOF

(71) Applicant: Color123, Ltd., Taipei City (TW)

(72) Inventor: TSUNG YI HSU, Taipei City (TW)

(21) Appl. No.: 15/862,629

(22) Filed: Jan. 4, 2018

(30) Foreign Application Priority Data
Jan. 6, 2017 (TW) 106100538

(51) Int. Cl. G06F 3/12; G06F 21/30

(52) U.S. Cl. CPC G06F 3/1203; G06F 21/30; G06F 3/1224; G06F 3/128

(57) ABSTRACT

A print output management system includes a management server, an output server and a large format equipment. The management server receives an original document file and converts the original document file to an output processing file, generates an authentication code corresponding to the output processing file, and stores the output processing file and the authentication code. The output server, connected with the management server, receives an access command which includes the authentication code, transmits the authentication code to the management server, accesses the output processing file corresponding to the authentication code from the management server, and outputs a print message corresponding to the output processing file. The large format output equipment, connected with the output server, includes a roll and a roll paper installed on the roll. The large format output equipment receives the print message, and prints the output processing file on the roll paper in accordance with the print message.

### BACKGROUND OF THE INNOVATION PATENT

### 1. Field of the Innovation patent

The present innovation patent relates to a print output management system and the method of operation thereof, particularly a print output management system and the method of operation thereof which applies to roll-printing.

### 2. The Related Arts

Print has been a demand in daily life, and is applied ubiquitously, such as a research, a conference, a wedding, and a funeral. Therefore, the technology relative to print has been developed and applied.

Formerly, printing electronic graphics at home is often restricted to whether there is a device for printing in the house, so most people will bring their electronic graphics, stored by a flash drive, to print store for printing services. Hence, people may wastes time and not get the best graphics without professional assistance, and the cost of printing will be increased because of consumption of paper and ink. Recently, there are many locations in which an auto printing device is set to people nearby, so it provides printing services and solves parts of the above mentioned problems.

However, in the prior art, an automated printing device are usually provided with a small-size paper, and must be operated by a user, wherein, most of the output paper are A4 paper. As a result, once we want to print a graphic having a large area specification, such as a photo and a poster on an exhibition, people still need to go to a print store for printing services. Moreover, it will take at least a couple of hours, even a couple of days, to get the graphic. Further, for one-to-one services, because the number of print and the operating ability of the previous user are unknown, the printing quality is unstable and the next user will be delayed, so as to cause an issue of the low efficiency.

### SUMMARY OF THE INNOVATION PATENT

Hence, an embodiment of the present invention provides a print output management system which includes a management server, an output server and a large format equipment.

The management server includes a storage module, the management server receives an original document file and converts the original document file to an output processing file, generates an authentication code corresponding to the output processing file, and stores the output processing file and the authentication code.

The output server, which is connected with the management server, receives an access command which includes the authentication code, transmits the authentication code to the management server, and accesses the output processing file corresponding to the authentication code from the management server, and outputs a print message corresponding to the output processing file.

The large format output equipment, which is connected with the output server, includes a roll and a roll paper installed on the roll. The large format output equipment receives the print message, and prints the output processing file on the roll paper in accordance with the print message.

The print output management system as above mentioned, in an embodiment, the management server further evaluates a cost detail in accordance with a print area specification of the output processing file, and stores the cost detail.

The print output management system as the above mentioned, in an embodiment, further includes a charging equipment which is connected with the output server, wherein the output server accesses the cost detail, generates a payment message in accordance with the cost detail and a number of the output processing file which has been printed, and transmits the payment message to the charging equipment.

The print output management system as above mentioned, further includes a monitoring equipment which is separately connected with the large format output equipment and the output server, wherein the monitoring equipment detects a state of the large format output equipment to generate a state information, and the monitoring equipment transmits the state information to the output server.

The print output management system as above mentioned, further includes another large format output equipment, wherein when the monitoring equipment determines, according to the print message, that the roll paper is too short to output the output processing file and a roll paper of the another large format output is enough to output the output processing file, the monitoring equipment transmits a warning message to the output server, and the output server transmits the print message to the another large format output equipment.

Further, an embodiment of the present invention provides a method of print output operation comprising the steps of:

A log-in step of logging to in a management server which includes a storage module.

An uploading step of uploading an original document file to the management server.

A document converting step of enabling the management server to convert the original document file to an output processing file, to generate an authentication code corresponding to the output processing file, and to store the output processing file and the authentication code.

An accessing step of enabling an output server to receive an access command which includes the authentication code, to transmit the authentication code to the management server, to access the output processing file corresponding to the authentication code from the management server, and to transmit the a print message which is corresponding to the output processing file to a large format output equipment.

A printing step of printing the output processing file on a roll paper when the large format output equipment receives the print message.

The method of print output operation as above mentioned, in an embodiment, further includes a verifying output specification step of enabling the management server to verify whether the original document file is matched with an output specification, performing the document converting step if the original document file is matched with the output specification, and generating an error information and stopping the document converting step if the original document file is not matched the output specification.

The method of print output operation as above mentioned, in an embodiment, wherein if the original document file is not matched with the output specification, the management server transmits an error notification to a terminal device, the terminal device transmits a confirm notification to the management, after the management server receives the confirm notification, the original document file will be adjusted to match another output specification and the document converting step will be performed.

The method of print output operation as above mentioned, in an embodiment, wherein if the original document file is not matched with the output specification, the management receives a confirm notification which is transmitted from the output server, the original document file will be adjusted to match with another output specification and the document converting step will be performed.

The method of print output operation as above mentioned, in an embodiment, wherein in the document converting step, the management server further compresses the output processing file.

By the platform provided by the management server for user printing, the original document file is received and converted to an output processing file, and an authentication code corresponding to the output processing file is generated to the user. Therefore, when the output server receives the authentication code entered by user, the output server can access the corresponding output processing file from the management server, so as to make the large-format output equipment to print. In this way, the operation mode of adjusting the document in the present invention is automatically processing by the system instead of by a human, so as to eliminate the human factors in control and allocation, and to provide a perfect automatically print processing. Thus, the unskilled printing operator can obtain the want-to-print document quickly by the print output management system of the present invention, and the printing quality and the efficiency of large-area paper print can be further improved. In addition, the monitoring equipment can detect the state of the large-format output equipment in real-time, and transmits the state information to the output server, the output server collects state information and transmit it to the management server, so the management server can perform each analyzation, statistics or warnings according to the state information. As the result, the print store can timely replace the supplies, repair or perform information research. While in printing, the monitoring equipment can determine whether the state of large-format output equipment is abnormal or not, and the printing supplies are insufficient or not, and the warning message can be timely generated and transmitted to the management server via the output server to inform the user or staff.

In addition, according to the method of print output operation of the present invention, the user uploads the want-to-print document in an efficient way, and the management server is further helping the user to performing format optimization or format confirmation to ensure the print quality on the time then. As a whole, the print output management system and the method of print output operation of the present invention is capable of effectively solving the problems encountered in the prior.

The advantage and features of the present invention will be described below, and as can be appreciated from the above embodiments, a person skilled in the art can achieve the above object. Therefore, the present innovation patent has industry worth which meets the requirement for a patent, so that the application is submitted.

### BRIEF DESCRIPTION OF THE DRAWINGS

FIG. 1 shows a structure diagram in accordance with an embodiment of a print output management system of the present invention;

FIG. 2 shows a flow diagram in accordance with an embodiment of a method of print output operation of the present invention; and

FIG. 3 shows a flow diagram in accordance with an embodiment of a print output operation of the present invention.

### DETAILED DESCRIPTION OF PREFERRED EMBODIMENT

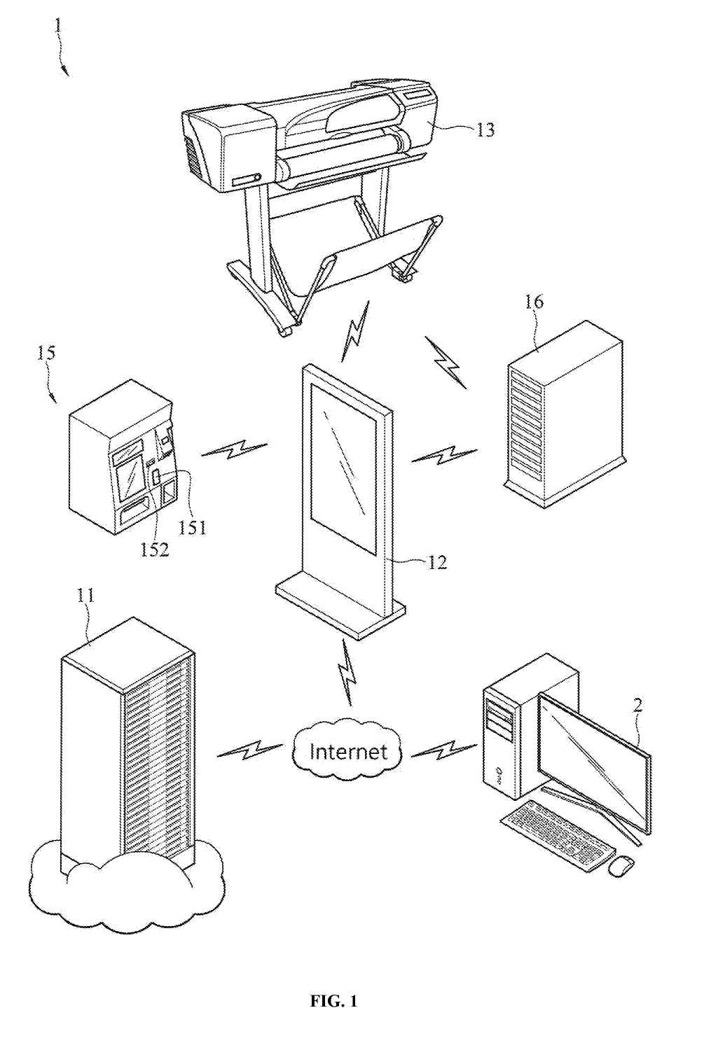

With reference to FIG. 1, FIG. 1 shows a structure diagram in accordance with an embodiment of a print output management system 1 of the present invention. The print output management system 1 includes a management server 11, an output server 12, and a large format output equipment 13.

The management server 11 includes a storage module. The management server 11 can be a computer. The management server 11 receives an original document file which is logged in and transmitted by a user. The user can log in to the management server 11 via a terminal device 2, and transmit the original document file to the management server 11. The terminal device 2 can be a computer, a laptop, or a smartphone. The embodiment is not to limit the present invention. The management server 11 converts the original document file to an output processing file, generates an authentication code corresponding to the output processing file, and stores the output processing file and the authentication code. The original document is the document that the user wants to print.

The authentication code is a kind of identification information, which can be name, contact number, password or serial number. The authentication code is corresponding to the output processing file. Thereby, the user logs in to the management server 11 and inputs the authentication code, and the management server 11 finds the stored output processing file according to the authentication code and provides it for the user.

The output server 12 is connected with the management server 11. The output server 12 receives an access command which includes the authentication code, transmits the authentication code to the management server 11, and accesses the output processing file corresponding to the authentication code from the management server. Then, the output server 12 outputs a print message corresponding to the output processing file. In other words, after the user uploads the original document file to the management server 11, the original document file is converted to the output processing file by the management server 11. For a user, when he wants to print, can go to a location where is provided with the output server 12 and the large format output equipment 13. The output server 12 can be a computer, as shown in FIG. 1. The output server 12 includes an inputting module, such as a touch screen, which is provided to the user to input the access command which includes the authentication code. The output server 12 transmits the access command to the management server 11. The management server 11 finds the corresponding output processing file according to the authentication code and transmits it to the output server 12. After the output server 12 received, the output server 12 transmits the print message to the large format output equipment 13 to print.

The large format output equipment 13 is connected with the output server 12, and includes a roll and a roll paper installed on the roll. The large format output equipment 13 receives the print message, and prints the output processing file on the roll paper in accordance with the print message. In an embodiment, the roll paper can be continuously printed as a paper having 90 cm by 9000 cm size. Moreover, the large format output equipment further includes a cutting device, and cuts a corresponding length and width according to the format of the output processing file.

The above mentioned output server 12 and the large format output equipment 13 can be provided everywhere, such as a department of a campus, a lecture hall, or a commercial office, to the user to operate. Further, the management server 11 is provided with cloud management services.

In an embodiment, the management server 11 further compresses the output processing file, that is to say that the management server 11 captures the necessary pixels and compress. Thereby, the storage space of the management server 11 can be used more efficiently, and the output processing file is transmitted to the output server 12 faster.

Further, in an embodiment, the management server 11 further evaluates a cost detail in accordance with a print area specification of the output processing file, and stores the cost detail. In other words, the management server 11 evaluates the cost of the output processing file and stores the cost detail after converts the output processing file. Hence, when the output server 12 receives the access command, the access command, which is inputted by the user, includes the numbers of print copies. The output server 12 evaluates a total amount of cost in accordance with the above mentioned cost detail.

With reference to FIG. 1, the print output management system 1 further includes a charging equipment 15 which is connected with the output server 12. The output server 12 transmits a payment message including the amount of cost to the charging equipment 15.

The charging equipment 15 can charge by sensing or swiping, such as a credit card or an electronic wallet, or by coins. Further, the charging equipment 15 can be a cashier machine and operated by a man. In an embodiment, the charging equipment 15 includes a sensing device 151 and a print receipt device 152. After the sensing device 151 charged the electronic wallet of the user successfully, the print receipt device 152 prints the receipt as a cost certificate, as shown in FIG. 1.

In an embodiment, the print output management system 1 further includes a monitoring equipment 16 which is separately connected with the large format output equipment 13 and the output server 12. The monitoring equipment 16 detects a state of the large format output equipment 13, such as the graphic state, the state of the remaining amount of paper and ink, and then generates a state information. The monitoring equipment 16 transmits the state information to the output server 12. The above mentioned monitor and detect is an embodiment of the present invention, and the embodiment is not to limit the present invention. For example, in other embodiment, the monitoring equipment 16 can detect whether the large format output equipment 13 has any other abnormal state.

In an embodiment, the print output system 1 further includes another large format output equipment 13. When the monitoring equipment determines, corresponding to the print message, that the roll paper is too short to output the output processing file and a roll paper of the another large format output is enough to output the output processing file, the monitoring equipment 16 transmits a warning message to the output server 12, and the output server 12 transmits the print message to the another large format output equipment 13 and enable it to print. In other words, there could be plurality of large format output equipments in one location. When the user operates to print, the monitor equipment will determine which large format output equipment could provide print services and precludes problems, such as temporarily unable to print, or material (like paper and so on) shortage.

The output server 12 also can determine in accordance with the received state information. The embodiment of the determining means of a monitoring equipment is not to limit the present invention. In an embodiment, a monitoring equipment and an output server 12 can be integrated into one machine, or can be provided separately.

In an embodiment, when the charging equipment 15 have not charged yet, the monitor equipment detects the consumption state of paper of the large format output equipment 13 and determines whether it is enough to print, transmits the state information to the output server 12 to tell the user the state, and further receives the confirm of the user (or the output server 12 confirms by itself). After the charging equipment 15 really charges successfully, transmits the payment notification to the output server 12. Subsequently, the output server 12 receives the payment notification, accesses the above mentioned output processing file, generates the print message and then transmits the print message to the large format output equipment 13. In other situation, the charging equipment 15 is connected with the management server 11. The charging equipment 15 transmits the payment notification to the management server 11. Thereby, the management server 11 transmits the output processing file to the output server 12, and the output server 12 further generates the print message and transmits it to the large format equipment 13.

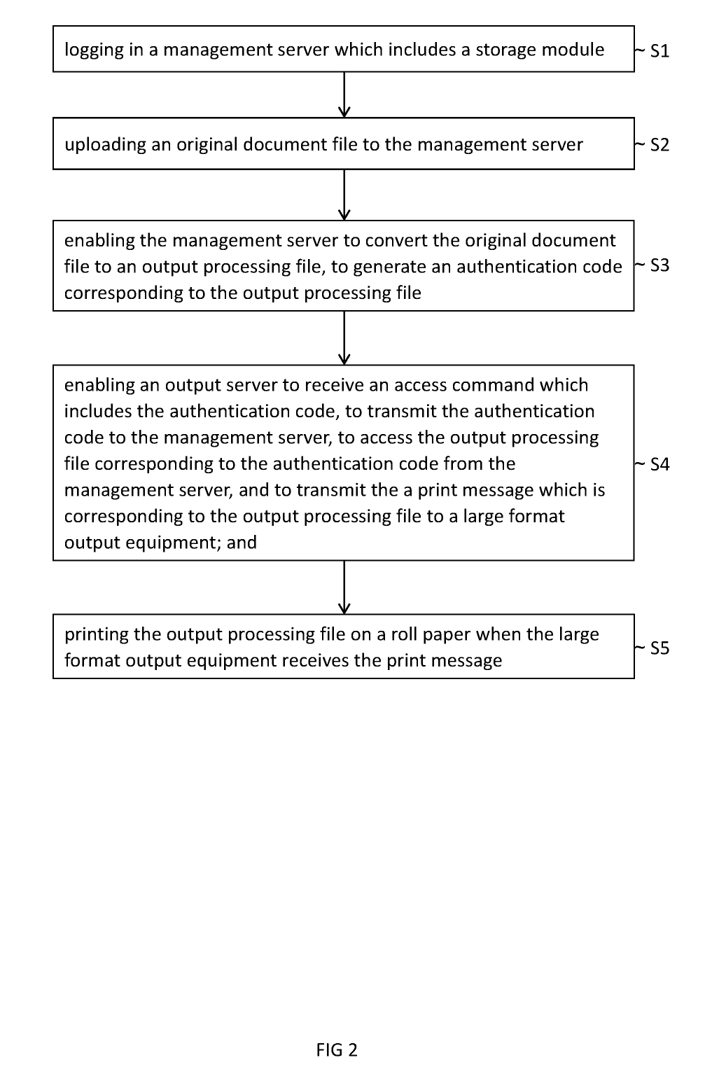

With reference to FIG. 1 and FIG. 2 again, FIG. 2 is flow diagram in accordance with an embodiment of a method of print output operation of the present invention, which includes the steps of:

Log-in step S1: Logging in to the management server 11, which the management server 11 includes the storage module. The user inputs information of identity recognition to log in to the management server 11, for example, such as name, phone number, birthday, e-mail or ID number, and the information is provided to the management server 11 for identification and storage.

In an embodiment, the management server 11 provides an online platform, and the user can log in to the management server 11 by providing the personal information, such as the personal account, the e-mail and other information in the manner of member registration.

The following step is uploading step S2: uploading an original document file to the management server 11. The user provides the original document, which is the original document (JPEG, PNG, PDF and other electronic format files) which the user wants to print, and uploads it to the management server 11.

In an embodiment, the user can describe the format of the original document file before or after uploading the original document file, and store the format, such as file name, number, file type, material (general paper, photo paper or other paper), the size and other information, in the management server 11. In addition, since the large-format output equipment 13 can be provided at variety of places, such as each business offices, each campus, the user can also pre-fill the format to one of the large-format output equipment 13 to perform print operation.

The following step is a document converting step S3: enabling the management server 11 to convert the original document file to an output processing file and to generate an authentication code corresponding to the output processing file, and to stores the output processing file and the authentication code. The document converting step is performed after the original document file is received by management server 11, and the original document file is converted into an output processing file and an authentication code, and the management server 11 stores the output processing file and the authentication code. The output processing file is a file formatted by the management server 11, and the said formatting can be a basic format adjustment, such as size of the specification, resolution, make-up, addition of background color, addition of cut line, or direct conversion processing. The authentication code corresponds to the output processing file, which can be the above mentioned message such as name, phone number, birthday or e-mail inputted by the user, or the authentication code can be a serial number generated by the management server 11.

In this step, the user has completed the steps of uploading the original document, and converting it into the output processing file, and storing it by the management server 11.

The following step is an accessing step S4: enabling an output server 12 to receive an access command which includes the authentication code, to transmit the authentication code to the management server 11, to access the output processing file corresponding to the authentication code from the management server, and to transmit the a print message which is corresponding to the output processing file to a large-format output equipment 13. That is, the user wants to output the uploaded original document, which inputs the access command including the authentication code, the output server 12 transmits the authentication code to the management server 11 to find the corresponding output processing file, and then transmits the outputs the processing file to the output server 12.

In an embodiment, the user can also use the terminal device 2, such as the cell phone, the notebook, or the PC, to log in to the management server 11, and transmit the authentication code, the management server 11 finds the output processing file according to the authentication code, and which is provided for the user to search.

The following step is a printing step S5: printing the output processing file on a roll paper when the large format output equipment 13 receives the print message.

By the step S1 to S5, the basic print process of the large format output is completed.

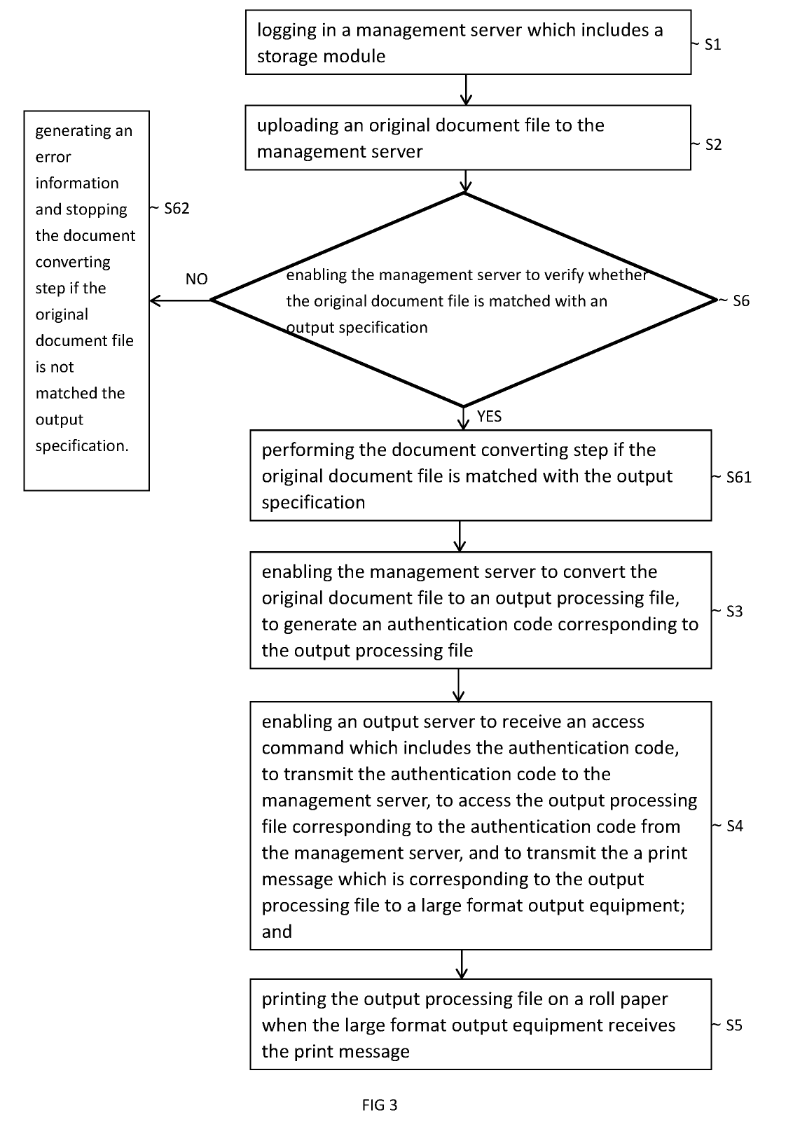

Please referring to the FIG. 3, which is a schematic flow chart of one embodiment of a method of print output operation according to the present invention. In this embodiment, a verifying output specification step S6 is further included of: enabling the management server 11 to verify whether the original document file match with an output specification or not. The verifying output specification step S6 includes a step S61 and a step S62, the step S61: performing the document converting step if the original document file doesn't matched with the output specification; step S62: generating an error information and stopping the document converting step if the original document file doesn't matched with the output specification.

The contents of the output specification mentioned above are the specification parameters, for example, such as the file format, the width & height of file, the color quality, the image resolution and deformation ratio. The output specification may be a default optimization parameter in the management server 11, so as to provide the user with an easy operation flow. Furthermore, the output specification may be inputted and transmitted by the user logging in to the management server 11 via the terminal device 2 or the output server 12.

After the original document being received by the management server 11, the verifying output specification step S6 is performed. If the management server 11 determines that the original document file is matched with the default optimized output specification mentioned above, the document converting step S3 is performed; if the management server 11 determines that the original document file does not matched with the optimized output specifications mentioned above, the error message will be generated and transmitted to the terminal device 2 or the output server 12 (depend on the way the user uploading the original image is by the terminal device 2 or by operating the output server 12) so as to warn the user which format errors may exist in the original document file, and provides a suggested output specification. On the other hand, the abnormal situation is also informed to the staff. At this time, the management server 11 is enabled to stop the document converting step. After receiving a confirm notification by the management server 11 (the user transmits it to the management server 11 via the terminal device 2 or the output control server 12), which means the user agree with the management server 11 to correct the error, the original document file will be adjusted to match with another preferred output specification, and the document converting step S3 is performed afterward.

More specifically, the output specification is configured by the user, if the management server determines the original document does not match with the output specification, the management server 11 is enabled to transmit an error notification to the terminal device 2 or the output server 12 (depending on situation where the user uploads the original document file is via the terminal device 2 or via the output server 12 by operating in the field), and provides the specification options including a file format, a file width & height, a color quality, an image resolution and a deformation ratio, which is provided for the user to reset, and the terminal device 2 or the output server 12 returns a confirm notification including the reset output specification to the management server 11, so as to indicate that the user is aware of the cause of the error and resets the parameters of output specifications After receiving the confirm notification, the management server 11 determines whether the original document file match with the reset output specification according to the confirm notification, and after the determination match, the management server 11 adjusts the original document file to match with the other output specification (that is the reset output specifications), and the document converting step S3 is performed then.

In an embodiment, after the step of document converting step S3, the management server 11 further determines the conversion of the output processing file is success or not. In other word, the management server 11 determines the file format, the width & height, the color quality, the image resolution, and the deformation ratio match with the configured output specification. After determining, the management server 11 is enabled to store the output processing file.

In an embodiment of the method of print output operation of the present invention, the management server 11 further provides a preview function for the users to watch the printing effect of the reference original document file or the output processing file by utilizing the terminal device 2 or the output server 12.

In an embodiment of the method of print output operation of the present invention, the management server 11 of the document converting step S3 further compresses the output processing file. In other words, the management server 11 compresses the output processing file, which the required storage space can be greatly reduced, and the output processing file can be quickly transferred to the output server 12. When printing, the output server 12 can transmit the print message to the large format output equipment 13 to execute the output only after decompressing the output processing file.

In an embodiment of the method of print output operation of the present invention, the management server 11 in document converting step S3 further evaluates a cost detail, which is calculated according to the output specifications, and the management server 11 stores the cost detail. The cost detail is not only available to be inquired for the user by logging in to the management server 11, at the printing step S5, the cost detail can also be used to calculate the consumption amount based on the cost details and the output number of the output processing file by the output server 12. The staff may charge for the consumption amount accordingly by human or by configuring a charging equipment 15, and the fee is paid by coins or by electronic purse-sensing method, which the present invention is not limited to it.

In an embodiment of the method of print output operation of the present invention, the output server 12 includes a reading device, which can receive the original document file via a wired or wireless communication, for example, the original document file can be transmitted by reading a flash drive or a memory card carried by the user, or by a proximity sensing method, such as Bluetooth, Near Field Communication (NFC), ZigBee and other communication technologies, so that the user can operate the output server 12 in the field to upload the original document file to management server 11.

A platform being capable of online verifying document format, compressing and storing is provided by the management server in accordance with the present invention, so the user can print anytime at the place where is provided with the output server and a large format output equipment, even the unskilled printing operator can accomplish the document print easily, so as to increase the efficiency of print. The present invention focus on large area paper print, the operation mode of adjusting the document in the present invention is automatically processed by the system instead of by a human, so as to eliminate the human factors in control and allocation, and to provide a perfect print quality. In addition, the monitoring equipment can detect the state of the large-format output equipment in real-time, and transmits the state information to the output server, the output server collects state information and transmits it to the management server, so the management server can perform each analyzation, statistics or warnings according to the state information. As the result, the staff can timely replace the supplies, repair or perform information research.

Further, by the means of the method of the present invention, the users can upload graphics more efficiently, and the management server also further helps the user to perform the format optimization or format confirmation so as to ensure the quality of print. Moreover, in an embodiment, the preview service is provided.

However, the above description should be considered as only the discussion of the preferred embodiments of the present innovation patent, and the claims of the present innovation patent is not limited to this. A person skilled in the art may make various modifications to the present innovation patent. Those modifications still fall within the spirit and scope defined by the appended claims.

What is claimed is:

1. A print output management system comprising:
a management server including a storage module, the management server receiving an original document file and converting the original document file to an output processing file, generating an authentication code corresponding to the output processing file, and storing the output processing file and the authentication code;
an output server, connected with the management server, receiving an access command which includes the authentication code, transmitting the authentication code to the management server, and accessing the output processing file corresponding to the authentication code from the management server, and outputting a print message corresponding to the output processing file; and
a large format output equipment, connected with the output server, including a roll and a roll paper installed on the roll, the large format output equipment receiving the print message, and printing the output processing file on the roll paper in accordance with the print message.

2. The print output management system as claimed in claim 1, wherein the management server further evaluates a cost detail in accordance with a print area specification of the output processing file, and stores the cost detail.

3. The print output management system as claimed in claim 2, further comprising a charging equipment which is connected with the output server, wherein the output server accesses the cost detail, generates a payment message in accordance with the cost detail and a number of the output processing file which has been printed, and transmits the payment message to the charging equipment.

4. The print output management system as claimed in claim 1, further comprising a monitoring equipment which is separately connected with the large format output equipment and the output server, wherein the monitoring equipment detects a state of the large format output equipment to generate a state information, and the monitoring equipment transmits the state information to the output server.

5. The print output management system as claimed in claim 4, further comprising another large format output equipment, wherein when the monitoring equipment determines, according to the print message, that the roll paper is too short to output the output processing file and a roll paper of the another large format output is enough to output the output processing file, the monitoring equipment transmits a warning message to the output server, and the output server transmits the print message to the another large format output equipment.

6. A method of print output operation comprising the steps of
a log-in step of logging in to a management server which includes a storage module;
an uploading step of uploading an original document file to the management server;
a document converting step of enabling the management server to convert the original document file to an output processing file, to generate an authentication code corresponding to the output processing file, and to store the output processing file and the authentication code;
an accessing step of enabling an output server to receive an access command which includes the authentication code, to transmit the authentication code to the management server, to access the output processing file corresponding to the authentication code from the management server, and to transmit the a print message which is corresponding to the output processing file to a large format output equipment; and
a printing step of printing the output processing file on a roll paper when the large format output equipment receives the print message.

7. The method of print output operation as claimed in claim 6, wherein in the document converting step, the management server further compresses the output processing file.

8. The method of print output operation as claimed in claim 6, further comprising a verifying output specification step of enabling the management server to verify whether the original document file is matched with an output specification, performing the document converting step if the original document file is matched with the output specification, and generating an error information and stopping the document converting step if the original document file is not matched the output specification.

9. The method of print output operation as claimed in claim 8, wherein if the original document file is not matched with the output specification, the management server transmits an error notification to a terminal device, the terminal device transmits a confirm notification to the management, after the management server receives the confirm notification, the original document file will be adjusted to match another output specification and the document converting step will be performed.

10. The method of print output operation as claimed in claim 9, wherein if the original document file is not matched with the output specification, the management receives a confirm notification which is transmitted from the output server, the original document file will be adjusted to match with another output specification and the document converting step will be performed.
